(19) United States
(12) Patent Application Publication
(10) Pub. No.: US 2021/0042610 A1
(43) Pub. Date: Feb. 11, 2021

(54) ARCHITECTURE TO COMPUTE SPARSE NEURAL NETWORK

(71) Applicant: THE REGENTS OF THE UNIVERSITY OF CALIFORNIA, Oakland, CA (US)

(72) Inventors: Mau-Chung Frank Chang, Los Angeles, CA (US); Li Du, La Jolla, CA (US); Yuan Du, San Diego, CA (US)

(73) Assignee: THE REGENTS OF THE UNIVERSITY OF CALIFORNIA, Oakland, CA (US)

(21) Appl. No.: 16/995,032

(22) Filed: Aug. 17, 2020

Related U.S. Application Data
(63) Continuation of application No. PCT/US2019/019306, filed on Feb. 22, 2019.
(60) Provisional application No. 62/634,785, filed on Feb. 23, 2018.

(51) Int. Cl. G06N 3/04; G06N 3/063

(52) U.S. Cl. CPC G06N 3/0454; G06N 3/063

(57) ABSTRACT

A system and method for computing a sparse neural network having a plurality of output layers, each of which has a neuron value. Processing engines (PEs) each have a local memory for storing neurons for use with different weight values in a following cycle. A multiplexer selects between the input neuron or the output of the memory. Output from the multiplexor is received along with a weight input to a multiplier whose output is directed to an integrator. A decomposition technique performs a network computation through the use of intermediate neurons when the input neuron is larger than the local memory capacity, and provides data reuse by reusing neurons stored in local memory. Neural systems can be implemented using a neural index to address each of multiple PEs and a parallel-serial first-in-first-out (FIFO) to serially store values in main memory.

### CROSS-REFERENCE TO RELATED APPLICATIONS

This application claims priority to, and is a 35 U.S.C. § 111(a) continuation of, PCT international application number PCT/US2019/019306 filed on Feb. 22, 2019, incorporated herein by reference in its entirety, which claims priority to, and the benefit of, U.S. provisional patent application Ser. No. 62/634,785 filed on Feb. 23, 2018, incorporated herein by reference in its entirety. Priority is claimed to each of the foregoing applications.

The above-referenced PCT international application was published as PCT International Publication No. WO 2019/165316 A1 on Aug. 29, 2019, which publication is incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to neural networks, and more particularly to computations performed in sparse neural networks.

### 2. Background Discussion

A sparse Neural Network (NN) has been widely reported as a way to reduce the amount of the matrix coefficients for computation. In S. Han et al., “Deep Compression: Compressing Deep Neural Networks with Pruning, Trained Quantization and Huffman Coding”, arXiv preprint arXiv:1510.00149, 2015, incorporated herein by reference in its entirety, the author notices that with proper pruning, the fully-connected neural network can frequently truncate 90% of its coefficients to 0, resulting in a sparse neural network. The recently reported NN hardware accelerator does not fit for computing this type of neural network, as it cannot bypass the computation of zero in the dataflow (See, Y. Chen et al., “An energy-efficient reconfigurable accelerator for deep convolutional neural networks”, IEEE Journal of Solid-State Circuits, vol. 52, no. 1, pp. 127-138, January 2017, incorporated herein by reference in its entirety). As the NN becomes sparser, a new efficient computing architecture that can benefit from the sparsity of the NN becomes the future NN architecture trends.

Accordingly, a need exists for enhanced techniques for performing computations in sparse neural networks. The present disclosure fulfills that need and provides additional benefits over previous technologies.

### BRIEF SUMMARY

This disclosure describes an efficient hardware architecture for computing a sparse neural network. The architecture can bypass the computation of zero in the dataflow, and the computed input neurons in each processing engine (PE) can be stored in the PE's local SRAM and re-used when computing the next output neuron. The architecture is also configured to utilize a decomposition technique to compute the dense network, by for example, computing the partial input neurons and generating an intermediate neuron. This intermediate neuron can be served as an additional input neuron and compute the final output together with other un-computed neurons.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A and FIG. 1B are block diagrams for a showing an embodiment of a processing engine (PE) and system utilizing multiple PEs in computing a sparse neural network according an embodiment of the present disclosure.

FIG. 2A through FIG. 2E are node distribution diagrams showing computing dense net and data reuse according to an embodiment of the presented disclosure.

### DETAILED DESCRIPTION

### 1. Hardware Architecture

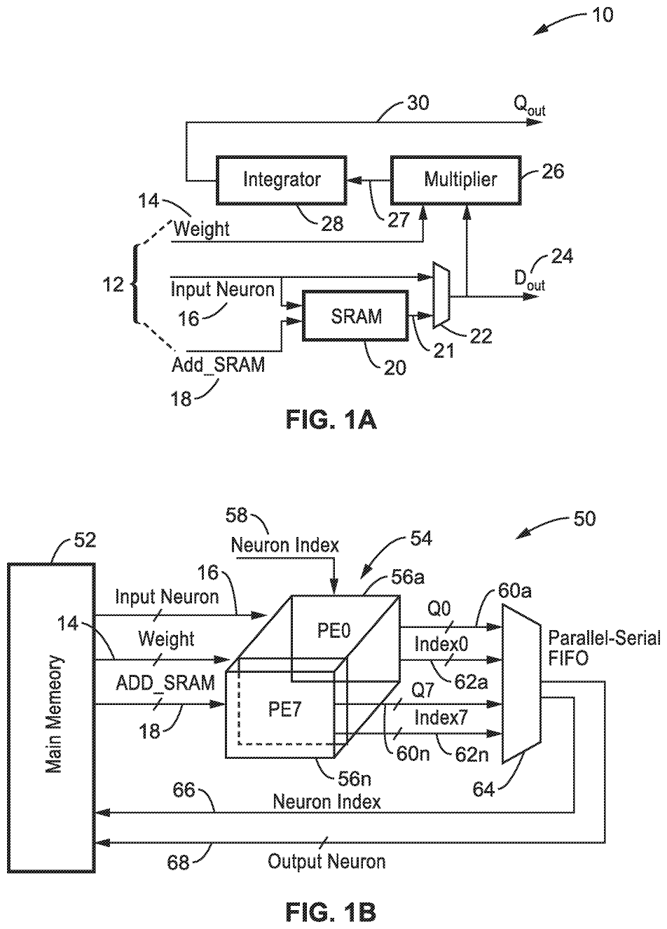

FIG. 1A and FIG. 1B illustrate example embodiments 10 of an efficient hardware architecture for computing a sparse neural network. In the embodiment shown, the computation of each output layer's neuron's value is through each processing engine (PE). The PE multiplies the coming weight and its input neuron in sequence, generates partial results for integration, and then outputs the final value. The weights stored in the main memory will be only the non-zero weights and the whole neural network (NN) will be described through relative address coding. An example of relative address coding is described in S. Han et al., “Deep Compression: Compressing Deep Neural Networks with Pruning, Trained Quantization and Huffman Coding”, arXiv preprint arXiv:1510.00149, 2015, incorporated herein by reference in its entirety. However, Han et al. does not describe any hardware-architecture implementation.

It should be appreciated that the architecture of the present disclosure bypasses the computation of zero in the dataflow. In addition, the computed input neurons in each PE will be stored in the PE's local SRAM and can be re-used when computing the next output neuron.

Each PE (Processing Engine) has multiple inputs 12, herein shown with a weight input 14 and a neuron input 16. The neuron will be stored in the local memory (e.g., SRAM) 20 and will be reused to compute with different input weight in the following cycle. The signal Add_SRAM 18 is a control signal to add the input neuron to the SRAM.

A multiplexor (MUX) 22 receives SRAM output 21 as well as the input neuron 16 and outputs Dₒᵤₜ 24, which also selects the proper input for a multiplier 26 when SRAM 20 is initially empty and will directly feed the input neuron to the multiplier. When the input neuron is already stored in the SRAM, it will read the neuron directly from SRAM and feed this value to the multiplier. The multiplier is seen multiplying the neuron by the weight value 14 and generating a multiplier output 27 to integrator 28.

The integrator 28 is configured for integrating the partial result coming from the multiplier and outputting the final results 30 after the integration in which all the corresponding neurons have been calculated and summed.

In FIG. 1B illustrates an example embodiment 50 of the whole system showing multiple PEs 54. It should be appreciated that in at least one embodiment of the present disclosure eight or more parallel PEs 56a through 56n can be implemented in the architecture depending on processing neural network complexity. A main memory 52 is shown from which weight 14, neuron input 16, and Add_SRAM 18 are generated to the parallel PEs. An additional Neuron Index line 58 is for marking the current output neuron's index.

As with other neural systems, control circuitry (not shown for the sake of simplicity of illustration) is utilized for generating control signals and address signals for each block. In particular, these control circuits provide addressing for the current input neuron and a neuron index for this neuron, while also enabling and disabling the PEs depending on the remaining output neuron numbers.

The processed results of the PE are depicted with an output Q and an index for each PE, the example depicting Q0 60a through Q7 60n, and Index0 62a through Index 7 62n. To avoid data congestion the PE array outputs are coupled to a parallel-to-serial first-in-first-out (FIFO) circuit 64 whose neuron index 66 and output neuron 68 values are fed back and stored in main memory 52. The stored neuron results in Main Memory will be used for coming the next layer's result. It will be appreciated that the neuron network has multiple layers, and that the engine calculates each layer based on the previous layer's output. So the current layer's output neuron is stored in Main Memory as the input neuron to calculate next layer's output.

The control block is configured to feed (output) the corresponding address of the main memory in each clock cycle to select the proper input neuron and weight that will be calculated in the next clock cycle.

### 2. Software Engine

The architecture can also use a decomposition technique to compute the dense network (e.g., where each output neuron's input neuron number is much larger than the local SRAM size). In one embodiment, this dense network computation can be achieved by computing the partial input neurons and generating an intermediate neuron. This intermediate neuron is served as an additional input neuron and computes the final output together with other un-computed neurons.

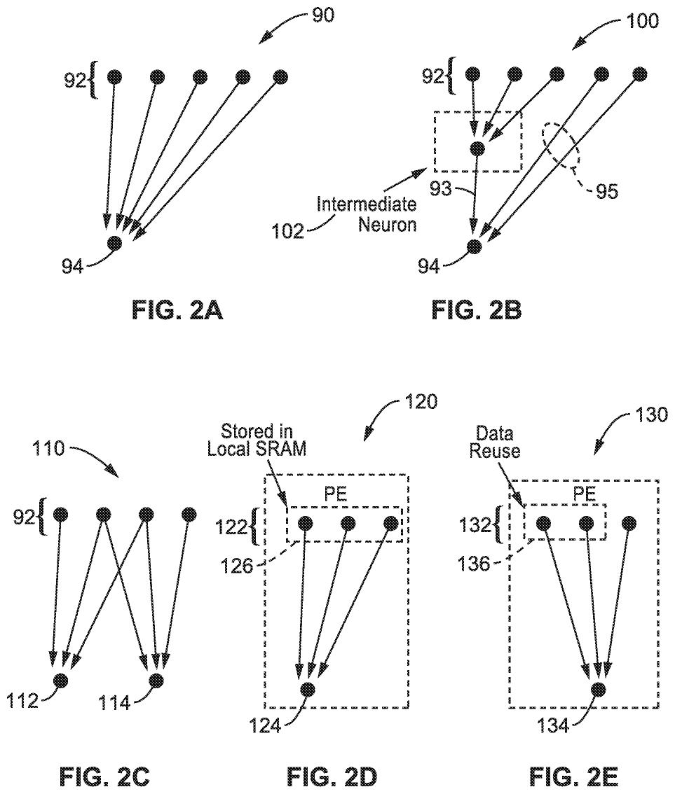

FIG. 2A through FIG. 2E illustrate embodiments related to computing dense networks in which local SRAM memory is not sufficient to store the neuron values for the whole layer. FIG. 2A illustrates an example 90 of a portion of a dense network computation with five neurons 92 that need to be calculated and an SRAM size 94 of three. In response to this situation, the present disclosure performs two steps in the calculation. In the first step seen in FIG. 2B 100 the first three outputs from neurons 92 are used to calculate the intermediate neuron 102. Then output 93 from intermediate neuron 102 will be calculated together at 94 with the remaining two neurons 95 from the five neurons 92 to get a final output. In response to this process the number of neural outputs received at input neuron 94 is reduced.

FIG. 2C through FIG. 2E illustrate one embodiment 110, 120, 130 of data reuse implemented to reduce the power consumption during computation of multiple neuron outputs. As often occurs in neural networks, the same neurons are fed multiple times to calculate different output neurons. Embodiment 110 of FIG. 2C depicts four neurons 92 from which groups of three outputs are calculated 112, 114. Thus, three input neurons from the group of four neurons 92 are used multiple times and computed at 112, 114. FIG. 2D illustrates 120 that these neurons 122 can be stored in local SRAM 126 and reused from SRAM to reduce power consumption of computation 124. After the three neurons finish all their calculation, then the remaining two neurons 132 seen in embodiment 130 in FIG. 2E are fed into the SRAM 136 and perform calculations 134 with multiple intermediate neurons to output a final result. It will be appreciated that current deep learning accelerators have not benefited from the sparsity of the neural network. In contrast, the technology described herein provides a new architecture that benefits from the sparsity of the neural network.

### 3. General Scope of Embodiments

The enhancements described in the presented technology can be readily implemented within various neural network systems. It should also be appreciated that neural network systems are often implemented to include control circuitry, which may contain one or more computer processor devices (e.g., CPU, microprocessor, microcontroller, computer enabled ASIC, etc.) and associated memory storing instructions and/or neural data/parameters (e.g., RAM, DRAM, NVRAM, FLASH, computer readable media, etc.) whereby programming (instructions) stored in the memory are executed on the processor to perform the steps of the various process methods described herein, and can extract data/parameters for the neural network from the memory.

The computer and memory devices were not depicted in the diagrams for the sake of simplicity of illustration, as one of ordinary skill in the art recognizes the use of computer devices for carrying out steps involved with controlling neural networks. The presented technology is non-limiting with regard to memory and computer-readable media, insofar as these are non-transitory, and thus not constituting a transitory electronic signal.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple embodiments which include, but are not limited to, the following:

1. A system for computing a sparse neural network having a plurality of output layers, each output layer having a neuron value, the system comprising: (a) a plurality of processing engines (PEs); and (b) a main memory configured to store input neurons and coming weights; (c) wherein each PE of said plurality of PEs is configured to receive a corresponding input neuron and coming weight from said main memory; and (d) wherein each said PE is configured to compute a neuron value of a corresponding output layer by multiplying the coming weight and input neuron from said neuron in sequence, generating partial results for integration, and outputting a final value.

2. A method for computing a sparse neural network, comprising: (a) configuring a plurality of processing engines (PEs) for a sparse neural network having a plurality of output layers, each output layer having a neuron value; (b) storing input neurons and coming weights; (c) receiving a corresponding input neuron and coming weight from said main memory within each PE of said plurality of PEs; and (d) computing a neuron value within each said PE of a corresponding output layer by multiplying the coming weight and input neuron from said neuron in sequence, generating partial results for integration, and outputting a final value.

3. The system or method of any preceding embodiment, wherein the coming weights stored in the main memory are only non-zero weights.

4. The system or method of any preceding embodiment, wherein said sparse neural network is described through relative address coding.

5. The system or method of any preceding embodiment, wherein computation of zero in data flow of the sparse neural network is bypassed.

6. The system or method of any preceding embodiment, wherein computed input neurons in each said PE are stored in PE memory for data reuse when computing a next output neuron.

7. The system or method of any preceding embodiment, wherein data reuse is implemented to reduce power consumption during multiple output neurons' computation.

8. The system or method of any preceding embodiment, wherein computation of each output neuron first uses any input neuron stored in the PE memory, and if the input neuron is not stored in the PE memory, then the PE reads the neuron from the main memory.

9. The system or method of any preceding embodiment, wherein seldom-used stored input neurons are replaced with frequently-used input neurons.

10. The system hardware architecture described herein as well as any combination of components, elements, or functional aspects thereof.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A system for computing a sparse neural network having a plurality of output layers, each output layer having a neuron value, the system comprising:
a plurality of processing engines (PEs); and
a main memory configured to store input neurons and coming weights;
wherein each PE of said plurality of PEs is configured to receive a corresponding input neuron and coming weight from said main memory; and
wherein each said PE is configured to compute a neuron value of a corresponding output layer by multiplying the coming weight and input neuron from said neuron in sequence, generating partial results for integration, and outputting a final value.

2. The system of claim 1, wherein the coming weights stored in the main memory are only non-zero weights.

3. The system of claim 1, wherein said sparse neural network is described through relative address coding.

4. The system of claim 1, wherein computation of zero in data flows of the sparse neural network is bypassed.

5. The system of claim 1, wherein computed input neurons in each said PE are stored in PE memory for data reuse when computing a next output neuron.

6. The system of claim 5, wherein data reuse is implemented to reduce power consumption during multiple output neurons' computation.

7. The system of claim 5, wherein computation of each output neuron first uses any input neuron stored in the PE memory, and if the input neuron is not stored in the PE memory, then the PE reads the neuron from the main memory.

8. The system of claim 7, wherein seldom-used stored input neurons are replaced with frequently-used input neurons.

9. A system for computing a sparse neural network having a plurality of output layers, each output layer having a neuron value, the system comprising:
a plurality of processing engines (PEs); and
a main memory configured to store input neurons and coming weights;
wherein the coming weights stored in the main memory are only non-zero weights;
wherein each PE of said plurality of PEs is configured to receive a corresponding input neuron and coming weight from said main memory;
wherein said sparse neural network is described through relative address coding; and
wherein each said PE is configured to compute a neuron value of a corresponding output layer by multiplying the coming weight and input neuron from said neuron in sequence, generating partial results for integration, and outputting a final value.

10. The system of claim 9, wherein computation of zero in data flows of the sparse neural network is bypassed.

11. The system of claim 9, wherein computed input neurons in each said PE are stored in PE memory for data reuse when computing a next output neuron.

12. The system of claim 11, wherein data reuse is implemented to reduce power consumption during multiple output neurons' computation.

13. The system of claim 12, wherein computation of each output neuron first uses any input neuron stored in the PE memory, and if the input neuron is not stored in the PE memory, then the PE reads the neuron from the main memory.

14. The system of claim 12, wherein seldom-used stored input neurons are replaced with frequently-used input neurons.

15. A system for computing a sparse neural network having a plurality of output layers, each output layer having a neuron value, the system comprising:
a plurality of processing engines (PEs); and
a main memory configured to store input neurons and coming weights;
wherein coming weights stored in main memory are only non-zero weights;
wherein each PE of said plurality of PEs is configured to receive a corresponding input neuron and coming weight from said main memory;
wherein computed input neurons in each said PE are stored in PE memory for data reuse when computing a next output neuron;
wherein said sparse neural network is described through relative address coding; and
wherein each said PE is configured to compute a neuron value of a corresponding output layer by multiplying the coming weight and input neuron from said neuron in sequence, generating partial results for integration, and outputting a final value; and
wherein computation of zero in data flows of the sparse neural network is bypassed.

16. The system of claim 15, wherein computation of each output neuron first uses any input neuron stored in the PE memory, and if the input neuron is not stored in the PE memory, then the PE reads the neuron from the main memory.

17. The system of claim 16, wherein seldom-used stored input neurons are replaced with frequently-used input neurons.

18. The system of claim 15, wherein data reuse is implemented to reduce power consumption during multiple output neurons' computation.

19. A method for computing a sparse neural network, comprising:
configuring a plurality of processing engines (PEs) for a sparse neural network having a plurality of output layers, each output layer having a neuron value;
storing input neurons and coming weights;
receiving a corresponding input neuron and coming weight from said main memory within each PE of said plurality of PEs; and
computing a neuron value within each said PE of a corresponding output layer by multiplying the coming weight and input neuron from said neuron in sequence, generating partial results for integration, and outputting a final value.

20. The method of claim 19, further comprising:
performing data reuse to reduce power consumption during multiple output neurons' computation; and
computing each output neuron so it first uses any input neuron stored in the PE memory, and if the input neuron is not stored in the PE memory, then the PE reads the neuron from the main memory.
